(19) United States
(12) Patent Application Publication
(10) Pub. No.: US 2024/0419506 A1
(43) Pub. Date: Dec. 19, 2024

(54) Efficiency Engine In A Cloud Computing Architecture

(71) Applicant: Microsoft Technology Licensing, LLC, Redmond, WA (US)

(72) Inventors: Rahul MOHANA NARAYANAMURTHY, Redmond, WA (US); Ye YU, Jiangsu Province (CN); Yixin FANG, Suzhou (CN); Si QIN, Beijing (CN); Jie YAN, Beijing (CN); Qingwei LIN, Beijing (CN); Maosen HUANG, Suzhou (CN); Tao SHEN, Suzhou (CN); Xiaofeng ZHEN, Suzhou (CN)

(21) Appl. No.: 18/685,745

(22) PCT Filed: Sep. 14, 2021
(86) PCT No.: PCT/CN2021/118181

§ 371 Date: Feb. 22, 2024

(51) Int. Cl. G06F 9/50; G06F 11/30

(52) U.S. Cl. CPC G06F 9/505; G06F 11/3006; G06F 2209/5019

(57) ABSTRACT

An efficiency engine identifies container sizes for containers of a workload and allocates the containers across server clusters and nodes based on peak resource usage requirements of the containers. Runtime feedback signals are generated from monitors within the containers indicative of a quality of service and resource usage. A decision engine can identify a bin packing action to take based upon the runtime feedback signals, and a control plane can perform the identified bin packing actions to adjust bin packing based upon the runtime feedback signals. Also, adaptive adjustment can be performed based on feedback signals and using a prediction engine.

### BACKGROUND

Computer systems are currently in wide use. Some computer systems are deployed in a remote server environment and host services or workloads.

The workloads or services are deployed in containers that have a corresponding amount of central processing unit (CPU) usage and memory requirements. The containers are allocated across different servers in what is sometimes referred to as a bin packing operation.

Current bin packing operations are optimized using resource efficiency as the optimization criteria. The optimization is performed from the perspective of the platform on which the workload or service is deployed.

The discussion above is merely provided for general background information and is not intended to be used as an aid in determining the scope of the claimed subject matter.

### SUMMARY

An efficiency engine identifies container sizes for containers of a workload and allocates the containers across server clusters and nodes based on peak resource usage requirements of the containers. Runtime feedback signals are generated from monitors within the containers indicative of a quality of service and resource usage. A decision engine can identify a bin packing action to take based upon the runtime feedback signals, and a control plane can perform the identified bin packing actions to adjust bin packing based upon the runtime feedback signals. Also, adaptive adjustment can be performed based on feedback signals and using a prediction engine.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2A and 2B (collectively referred to herein as FIG. 2) show a flow diagram illustrating one example of performing bin packing operations.

FIG. 3 is a flow diagram illustrating one example of performing container size optimization.

FIG. 4 is a flow diagram illustrating one example of assigning a service (or workload) to a set of clusters and nodes.

FIG. 5 is a flow diagram illustrating one example of assigning a plurality of different services or workloads to a set of clusters and nodes.

FIG. 6 is a flow diagram illustrating one example of how bin packing actions can be taken based upon real time monitoring of a workload.

FIG. 7 is a block diagram of one example of a computing environment.

### DETAILED DESCRIPTION

As discussed above, some current systems use a cloud control plane to allocate resources to different workloads by attempting to optimize resource efficiency from the perspective of the platform on which the workload is deployed. This operation of assigning a workload to servers is sometimes referred to as bin packing. The bin packing process is often only performed once during onboarding of the workload to servers that are running the workload. This bin packing process is also agnostic to how the container is actually used and does not adapt to changing workload conditions.

This type of process thus results in a number of significant drawbacks. For instance, most of the time, the workload uses only a low fraction of the requested resources, because the resources may be requested based upon an estimate of peak usage. Therefore, the container requests and holds resources for the highest usage or for at least a high percentage of the peak usage (such as 95% of peak usage). This results in a great deal of wasted resources. Further, during the rare times of peak usage (such as during large traffic spikes), the container may not have enough resources to work at full performance. Therefore, the platform may need to throttle usage, increasing latency, or may even crash. In addition, once the container is allocated to a server, the container cannot change the number of resources allocated to it, in order to better fit the actual workload usage.

The present description thus proceeds with respect to a resource allocation system that receives monitor signals from running workloads in containers indicative of resource allocation metrics, such as quality of service (QOS) and resource usage. Examples of QoS can include a measure of latency or throughput. Examples of resource usage can include CPU/memory/network usage. A decision engine accesses a bin packing policy and identifies any bin packing actions (such as reallocation of resources, etc.) that should be taken based upon the monitor signals from the containers and the running workloads. In addition, a prediction engine can generate predictive metrics and the bin packing actions can be based on the predictive metrics. The bin packing actions are provided to a control plane which executes the bin packing actions to reallocate resources.

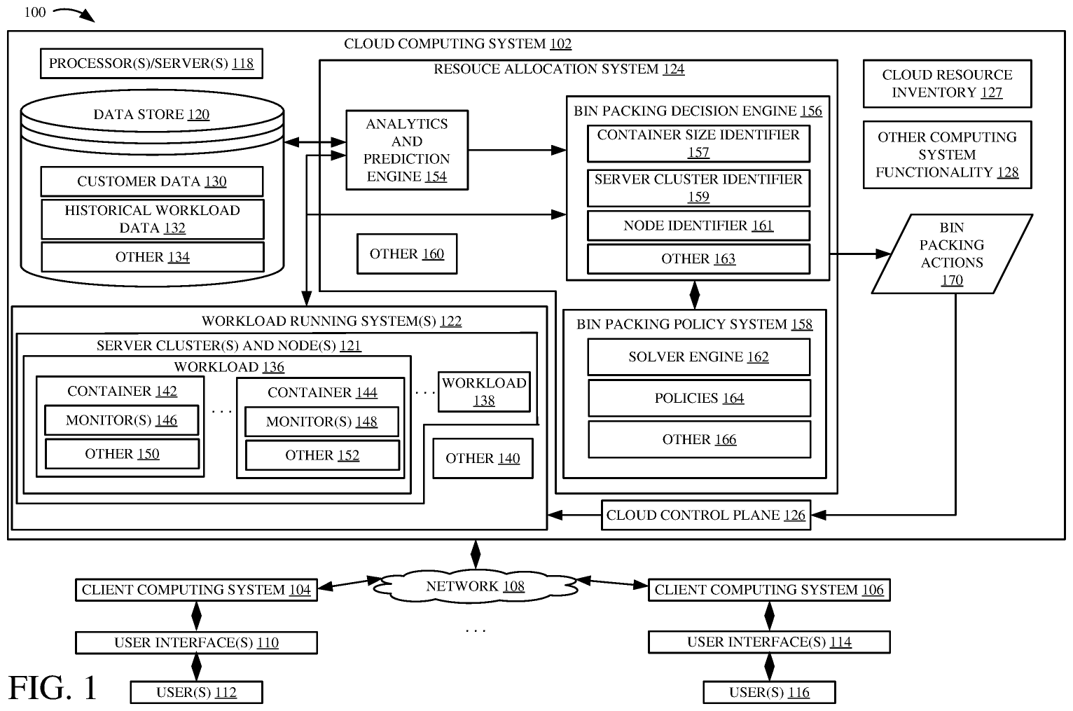

FIG. 1 is a block diagram of one of one example of a computing system environment 100 that includes a cloud computing system 102 which may be accessed by a plurality of client computing systems 104-106 over network 108. Network 108 can thus include a wide area network, a local area network, a near field communication network, a Wi-Fi network, a cellular communication network, or any of a wide variety of other networks or combinations of networks.

FIG. 1 also shows that client computing system 104 generates one or more user interfaces 110 for interaction by user 112. User 112 interacts with user interfaces 110 in order to control and manipulate client computing system 104 and some portions of cloud computing system 102. Similarly, client computing system 106 generates user interfaces 114 for interaction by user 116. User 116 interacts with user interfaces 114 in order to control and manipulate client computing system 106 and some portions of cloud computing system 102.

In the example shown in FIG. 1, cloud computing system 102 includes one or more processors or servers 118, data store 120, workload running system 122, resource allocation system 124, cloud control plane 126, cloud resource inventory 127, and other computing system functionality 128. Data store 120 illustratively includes customer data 130, historical workload data 132, and other items 134. Workload running system 122 can include functionality for running workloads 136-138, such as a plurality of servers arranged in server clusters and server nodes 121. The clusters may be arranged based on a wide variety of different criteria, and the different servers within each cluster may represent individual nodes within that cluster. System 122 can include other items 140 as well.

Each of the workloads 136-138 illustratively represent one or more services that are deployed in containers 142-144. The containers 142-144 include monitors 146-148 and other items 150-152. As is discussed in greater detail below, monitors 146-148 perform runtime monitoring of various characteristics and parameters of the workloads to which they belong. The characteristics and parameters can include quality of service parameters, resource usage parameters, among others.

Workload running system 122 illustratively includes a front end that exposes an interface so that client computing systems 104-106 can interact with the various workloads 136-138 that are running on the servers and nodes 121 in system 122. Workload running system 122 also illustratively includes a backend system that interacts with and modifies customer data 130 based upon the interactions from client computing systems 104-106.

Resource allocation system 124 can include analytics and prediction engine 154, bin packing decision engine 156, bin packing policy system 158, and other items 160. Bin packing policy system 158 can include a solver engine 162, one or more policies 164, and other items 166. Bin packing decision engine 156 can include container size identifier 157, server cluster identifier 159, node identifier 161, and other items 163.

Analytics and prediction engine 154 can access historical workload data 132 that represents historical QoS and resource usage of the various containers in which each workload 136-138 is running. Analytics and prediction engine 154 can also obtain an input from the various feedback monitors 146-148 in the containers corresponding to a workload. Based upon these inputs, analytics and prediction engine 154 generates an output indicative of a predicted future state of the particular workload 136 under analysis. The future state will illustratively identify the predicted future resource usage and QoS of the workload in the containers under analysis.

Bin packing decision engine 156 receives the estimate or prediction from analytics and prediction engine 154 and also receives inputs from the various feedback monitors 146-148 in the containers 142-144 that are running the workload 136 under analysis. In order to efficiently deploy the containers 142-144 into clusters of servers, container size identifier 157 identifies (e.g., optimizes) the container size for deployment across different server clusters in different nodes. For instance, assume that a server has four central processing units (CPUs) and one gigabyte of memory. Also, assume that the containers are sized so that one container requests three CPUs and 500 megabits of memory and another container requests two CPUs and 500 megabits of memory. In that case, the containers cannot be efficiently assigned to the different servers. Therefore, container size identifier 157 identifies efficient container sizes so that the containers can be assigned across multiple servers in an efficient way. Server cluster identifier 159 identifies a server cluster where the containers should be assigned, and node identifier 161 identifies one or more nodes within the identified server cluster where the containers are to be deployed.

Based upon the current values of the feedback monitor signals generated by monitors 146 and 148 (e.g., based upon the currently sensed resource usage and QoS) and based upon the prediction generated by an analytics and prediction engine 154, bin packing decision engine 156 accesses bin packing policy system 158. The solver engine 162 receives the inputs from bin packing decision engine 156 and accesses various policies or models 164. Solver engine 162 generates an output indicative of the desired resources that should be assigned to each container and provides that output to bin packing decision engine 156. Bin packing decision engine 156 generates an output indicative of bin packing actions 170 that should be performed in order to allocate the resources to accomplish the desired resources that should be allocated to each of the containers 142-144 in the workload 136 under analysis. The bin packing actions 170 can include, for example, optimizing the size of each of the containers 142-144 in terms of allocated CPU usage, memory usage, network usage, etc. The bin packing actions 170 can also include assigning the containers to different clusters of servers and to different nodes within those clusters. The bin packing actions 170 are provided to cloud control plane 126 which executes those actions to reallocate resources, to resize the containers, to assign the containers to different clusters or different nodes, or to perform other bin packing actions 170.

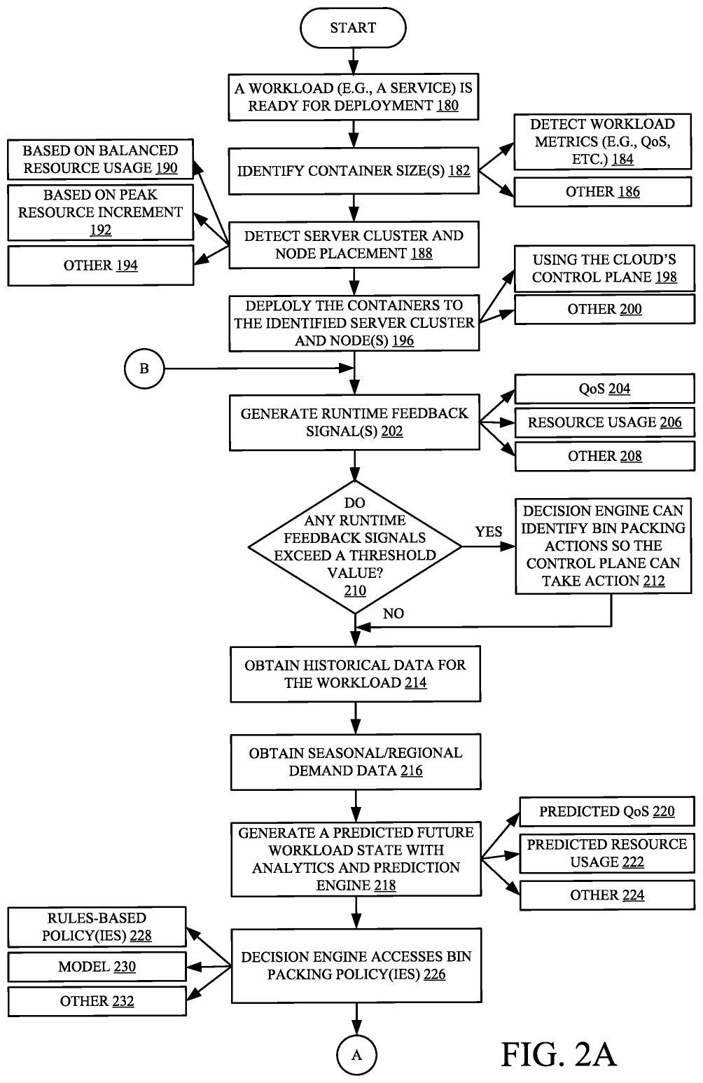

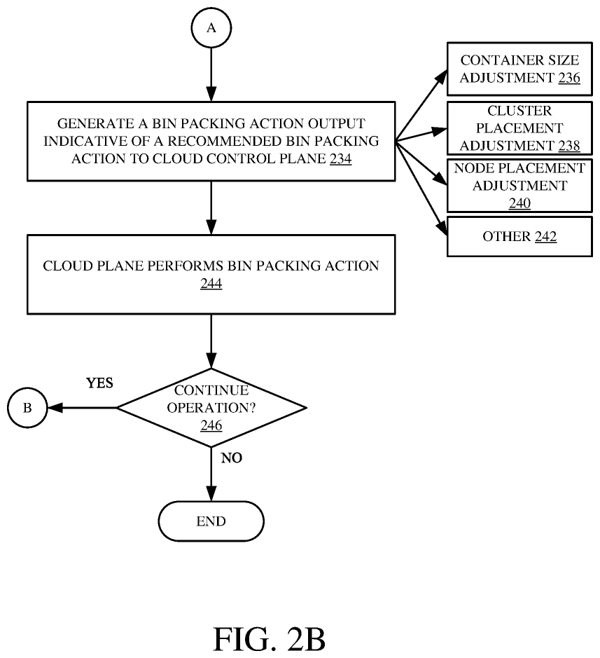

FIGS. 2A and 2B (collectively referred to herein as FIG. 2) illustrate a flow diagram showing one example of how a single workload is onboarded to workload running system 122 in cloud computing system 102. It is assumed that a workload is ready for deployment in workload running system 122 of cloud computing system 102. Having a workload ready for deployment is indicated by block 180 in the flow diagram of FIG. 2.

Container size identifier 157 then identifies an efficient set of container sizes for containers 142-144 that will be used to implement the workload 136. Identifying container sizes is indicated by block 182 in the flow diagram of FIG. 2. The container sizes can be identified based upon detected workload metrics, such as latency, resource usage, etc. as indicated by block 184. The container sizes can be identified in other ways as well, as indicated by block 186.

Server cluster identifier 159 then identifies the particular server cluster 121 for deployment of the containers 142-144 in workload 136. Node identifier 161 identifies the particular node for deployment of those containers. Detecting the server cluster and node placement is indicated by block 188 in the flow diagram of FIG. 2. Identifying the server cluster and node placement can be based on a determination as to how to achieve a best balanced resource usage, as indicated by block 190. The placement on a particular server cluster and node can be based on peak resource usage of the workload as indicated by block 192, or based on other criteria 194.

Once the server cluster and nodes are identified for placement of the containers for workload 136, an indication of this placement is output as bin packing actions 170 to cloud control plane 126. Cloud control plane 126 then deploys the containers to the identified server cluster and nodes, as indicated by block 196 in the flow diagram of FIG. 2. The particular workloads to put on the same server cluster is identified to better fit the hardware resource needs of the various workloads. For instance, workloads with a peak resource usage at one time may be placed on the same server cluster and/or node as a workload with a peak resource usage at a different time so that both workloads are not expected to hit peak resource usage at the same time. This is just one consideration and the deployment of the containers to the identified server clusters and nodes can be done in other was as well. Deploying the containers using the cloud control plane 126 is indicated by block 198 in the flow diagram of FIG. 2. The containers can be deployed in other ways as well, as indicated by block 200.

The monitors 146-148 in the various containers 142-144 generate runtime feedback signals which can be provided to resource allocation system 124. Generating the runtime feedback signals is indicated by block 202 in the flow diagram of FIG. 2. The runtime feedback signals can be generated by monitors that monitor the quality of service (as indicated by latency) corresponding to a particular container, as indicated by block 204. The runtime feedback signals can be generated by a monitor that monitors resource usage 206 instantaneously or over time. The runtime feedback signals can be other signals generated by other monitors as well, as indicated by block 208.

The feedback signals are fed back from the various monitors 146-148 to both the analytics and prediction engine 154 and the bin packing decision engine 156 in resource allocation system 124. Decision engine 156 then determines whether any of the runtime feedback signals exceed a threshold value, as indicated by block 210. If so, decision engine 156 can immediately generate an output identifying a bin packing action 170 to take so that cloud control plane 126 can take that action. Generating the bin packing action is indicated by block 212 in FIG. 2. For instance, if the latency signal indicates that the latency has exceeded a threshold latency value, or that the platform is throttling the processing of requests in the workload, then decision engine 156 may generate an output to perform a local adjustment to the workloads, such as to evict some lower priority workloads to migrate the workloads to a different node, or to perform a more large scale adjustment, such as to create more containers for the service and perform bin packing for the new containers.

If, at block 210, it is determined that the feedback signals do not exceed a threshold value, then analytics and prediction engine 154 obtains the historical workload data 132 for the workload 136 under analysis so that a prediction of the future workload state can be made. This is indicated by block 214 in the flow diagram of FIG. 2. The historical workload data 132 may be representative of seasonal and regional demand data so that seasonal and regional demand data can be obtained as well, as indicated by block 216. For instance, it may be that certain workloads are used more heavily during the school year than during the summer months. This is just one example and a wide variety of other seasonal or regional demand data can be obtained.

Based upon the runtime feedback signals and the historical workload data 132, analytics and prediction engine 154 generates a predictive future workload state for workload 136, as indicated by block 218. The future workload state can be indicative of a predictive quality of service (or latency) 220, a predicted resource usage level 222, or other predicted future values indicative of the state of the workload 136, as indicated by block 224.

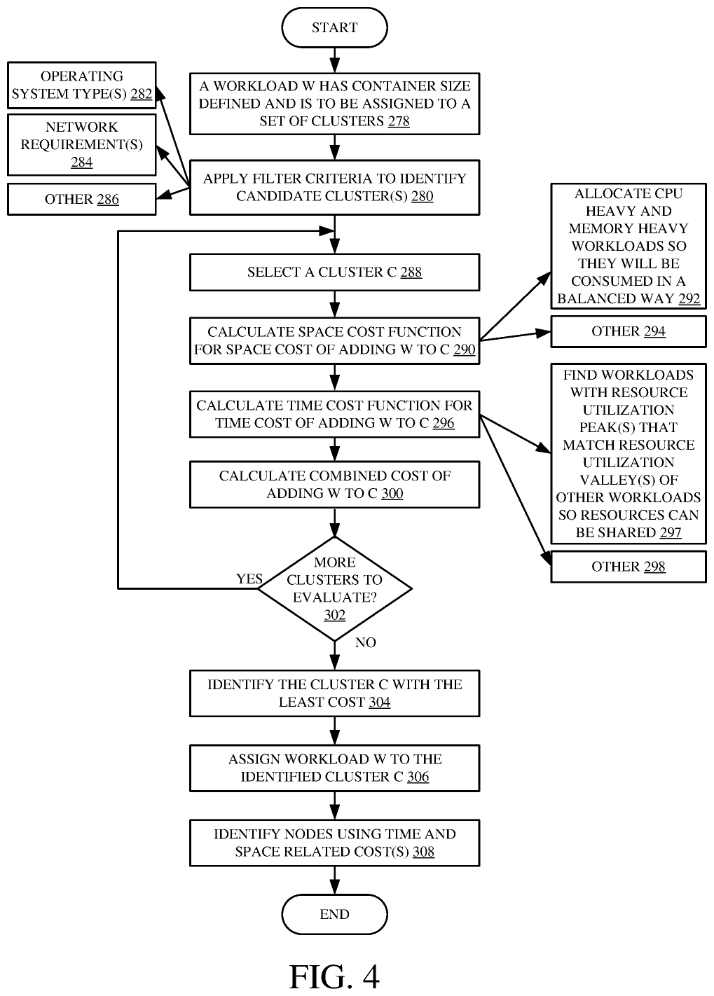

Based upon the feedback signals, and the output from analytics and prediction engine 154, bin packing decision engine 156 accesses the bin packing policy system 158, as indicated by block 226. The policies 164 that are used by solver engine 162 in bin packing policy system 158 may be rules-based policies or heuristic policies, as indicated by block 228 in the flow diagram of FIG. 4. The policies may be represented in a model 230 or in other ways 232. The solver engine 162 identifies the various levels of resources that should be allocated to the containers based upon the policies and the information received from runtime feedback monitors and from the analytics and prediction engine 154. Based upon that information, bin packing decision engine 156 generates a bin packing action output indicative of a recommended bin packing action 170 that should be taken by cloud control plane 126. Generating the bin packing action output is indicated by block 234 in the flow diagram of FIG. 2. The bin packing action may be based upon an output from container size identifier 157 to make a container size adjustment 236. The bin packing action may be an output from server cluster identifier 159 to make a cluster placement adjustment 238 to place the containers in one or more different clusters. The bin packing action may be based upon an output from node identifier 161 to perform a node placement adjustment action to adjust the placement of the containers on different nodes, as indicated by block 240. The bin packing action can be any of a wide variety of other bin packing actions 242 as well.

Cloud control plane 126 then performs the bin packing action 170, as indicated by block 244. Until the operation of the system is complete, as indicated by block 246, the operation continues at block 202 where the runtime feedback signals generated by monitors 146-148 are continually monitored.

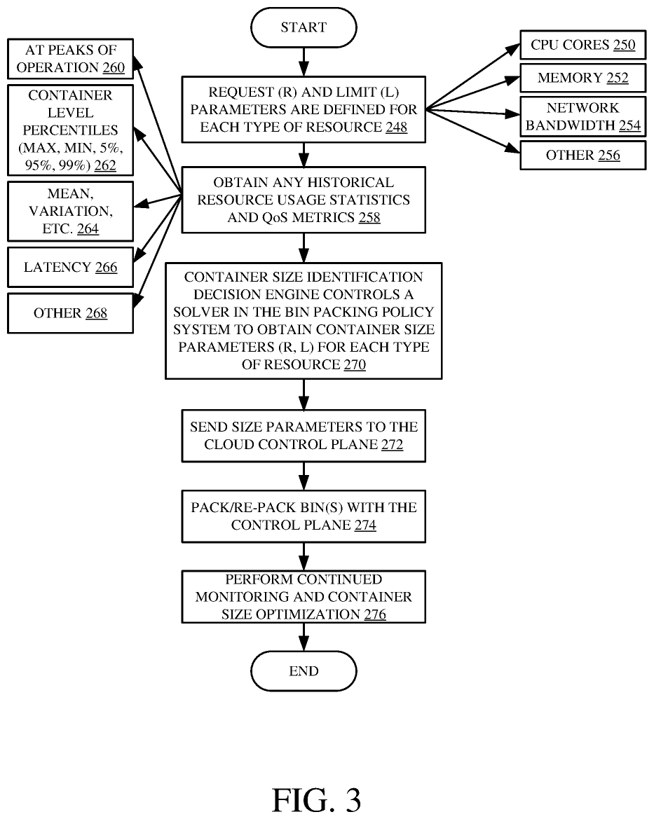

FIG. 3 is a flow diagram illustrating one example of the operation of container size identifier 157 in optimizing or otherwise selecting or identifying the sizes of the various containers 142-144 in which the workload 136 will be deployed. It is first assumed that a request (R) and a limit (L) are parameters that are defined for each type of resource in cloud resource inventory 127. Defining the request (R) and limit (L) is indicated by block 248 in the flow diagram of FIG. 3. The request represents the amount of resources that may be required by a container once the container is scheduled. This amount of resources may then be reserved from the cloud resource inventory 127 and occupied exclusively by the particular container that has requested the resources. The limit may be the maximum amount of resources that can be used by the container. In one example, the container may temporarily use more than the requested amount R (though this may not be guaranteed) but may not use more than the limit L of the resources. The resources for which a request and limit may be defined may include CPU cores 250, memory 252, network bandwidth 254, and other resources 256.

The container size identifier 157 may obtain the request and limit amounts as well as any historical resource usage statistics and quality of service metrics for the workload, as indicated by block 258 in the flow diagram of FIG. 3. The resource usage and quality of service metrics may be at peak operation times 260, and they may identify container level percentages, such as the peak usage, the maximum and minimum usage, the different percentiles of usage, such as 5%, 95%, 99%, etc. Identifying the historical resource usage in terms of container level percentiles is indicated by block 262 in the flow diagram of FIG. 3. The historical resource usage statistics may include the mean, variance, and other information, as indicated by block 264, latency information 266, and any of a wide variety of other resource usage statistics and quality of service metrics, as indicated by block 268.

Based upon the historical resource usage statistics and quality of service metrics, the container size identifier 157 in decision engine 156 controls the solver engine 162 in bin packing policy system 158 to obtain container size parameters (R and L) for each of the different types of resources being considered. Obtaining the container size parameters for each type of resource is indicated by block 270 in the flow diagram of FIG. 3. The container size parameters are then sent as part of a bin packing action 170 to cloud control plane 126, as indicated by block 272. The cloud control plane 126 then packs or repacks bins (e.g., defines the container sizes), as indicated by block 274. Resource allocation system 124 then performs continued monitoring and container size identifier 157 performs continued container size optimization, as indicated by block 276.

An example of container size identification may be helpful. To optimize the container request R with a confidence level a, assume K containers of the same workload are to be placed in one node. Assume that, at a time t the resource usage is defined as follows:

$${\{ {X}_{i}^{t} \}}_{i = 1 , 2 , … , K} \qquad EQ . 1$$

Assume that the resource usage defined in Equation 1 is identically and independently distributed, as is the quality of service in terms of latency, represented as follows:

$${\{ {δ}_{i}^{t} \}}_{i = 1 , 2 , … , K} \qquad EQ . 2$$

In order to determine the value of the requested resources, all of the resource usage values indicated by Equation 3:

$${\{ {X}_{i}^{t} \}}_{i ∈ ( K ) , t ∈ ( {t}_{k 1} , {t}_{k 2 ,} … , {t}_{k n} )} \qquad EQ . 3$$

are collected, and then container size identifier 157 computes the best values of R that meet the following constraints:

$$probability ( \frac{max}{t} {\sum }_{i = 1}^{k} {x}_{i}^{t} \leq K r ) \geq ∝ \qquad EQ . 4$$

$$probability ( \frac{max}{t , i} {δ}_{i}^{t} \leq Δ ) \geq ∝ \qquad EQ . 5$$

where Δ is a latency constraint. This is just one example of how the solver engine 162 may solve the problem of identifying optimal requested resources given the policies 164 which define the confidence level and algorithmic processes for evaluating Equations 1-5. Other ways of identifying the requested resources can be used as well.

FIG. 4 is a flow diagram illustrating one example of how server cluster identifier 159 and node identifier 161 are used to place the containers for a single workload, once they have been sized by container size identifier 157, on different server clusters and nodes, in an efficient way.

It is first assumed that a workload that is to be placed on a server cluster and one or more server nodes has had its container sizes optimized by container size identifier 157, as indicated by block 278 in the flow diagram of FIG. 4. Server cluster identifier 159 first applies filter criteria to identify candidate server clusters from cloud resource inventory 127, as indicated by block 280. The filter criteria can filter the various server clusters available in cloud resource inventory 127 based upon the type of operating system in the server clusters, as indicated by block 282, based upon the network requirements of the workload, as indicated by block 284, or based upon a wide variety of other filter criteria 286.

Once a set of candidate clusters have been identified, then server cluster identifier 159 selects one of the server clusters C, as indicated by block 288 and calculates a space cost function for the space cost of adding workload W to cluster C, as indicated by block 290. In one example, the cost function attempts to allocate CPU heavy and memory heavy workloads to clusters so that they will be consumed in a balanced way, as indicated by block 292. The cost function may compute a space cost in other ways as well, as indicated by block 294.

Server cluster identifier 159 then calculates a time cost function for the cost of adding workload W to the server cluster C. The time cost function may find services with resource utilization peaks that match the resource utilization valleys of other workloads so that the resources in the server cluster can be shared among those workloads without sacrificing performance, as indicated by block 297. The time cost function can be implemented in other ways as indicated by block 296.

Server cluster identifier 159 then calculates the combined cost (both the space and time cost) of adding workload W to cluster C, as indicated by block 300. If there are more candidate functions to consider, as indicated by block 302, then processing reverts to block 288 where the next candidate cluster is selected for evaluation.

Once all of the candidate clusters have been evaluated, then server cluster identifier 159 identifies the particular server cluster C that has the least cost, as indicated by block 304. The workload W is then assigned to the identified cluster C, as indicated by block 306.

Node identifier 161 can then identify the particular node within the server cluster C using both time and space related costs, in a similar way to which the particular server cluster C was identified. Identifying the nodes for assignment of containers for workload W is indicated by block 308 in the flow diagram of FIG. 4. Once sever cluster C and server nodes have been identified for deployment of the containers for workload W, they can be output along with bin packing actions 170 to control plane 126 which can assign the containers for workload W to the server cluster C and the identified nodes in cloud resource inventory 127.

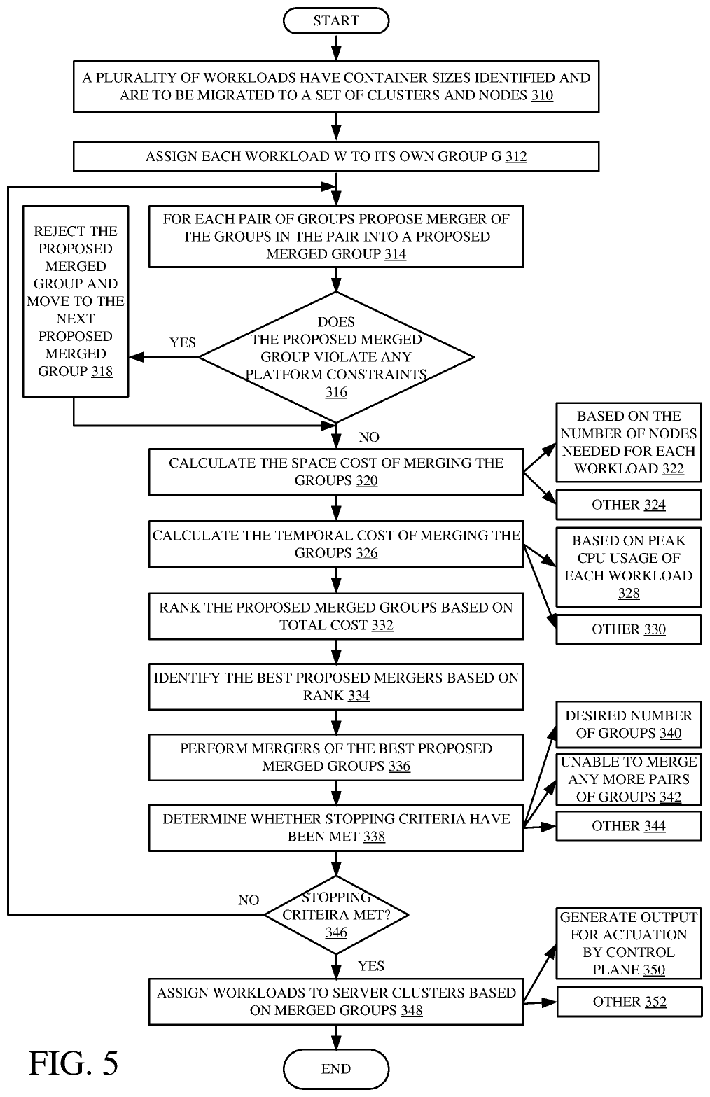

FIG. 5 is a flow diagram illustrating one example of the operation of server cluster identifier 159 and node identifier 161 in assigning a plurality of different workloads to server clusters and nodes. The workloads are grouped into groups and the groups are then assigned to server clusters and nodes. is first assumed that a plurality of workloads have container sizes identified and are to be migrated to a set of server clusters and nodes in workload running system 122, as indicated by block 310.

Each workload W is then assigned to its own group G, as indicated by block 312. Then, for each pair of groups, a merger is proposed to merge the pair of groups into a merged group, as indicated by block 314.

Server cluster identifier 159 then determines whether the proposed merged group violates any platform constraints, as indicated by block 316. If so, the proposed merger is rejected and processing continues with respect to the next proposed merged group, as indicated by block 318. However, if, at block 316, the proposed merged group does not violate any platform constraints, then server cluster identifier 159 calculates the space cost of merging the two groups of workloads together, as indicated by block 320. Again, the space cost of merging the two workloads can be based upon the number of nodes needed for each workload, as indicated by block 322, or other space considerations 324.

Server cluster identifier 159 then calculates the temporal cost of merging the groups, as indicated by block 326. The temporal cost can be based on the peak CPU usage of each workload, as indicated by block 328, or based upon other cost criteria, as indicated by block 330.

Server cluster identifier 159 then calculates the total cost of each of the proposed merged groups and ranks the proposed merged groups based upon the total cost associated with each proposed merged group, as indicated by block 332. The top N best proposed merged groups are identified based upon their rank, as indicated by block 334. Server cluster identifier 159 then merges the best N merged groups, and determines whether stopping criteria have been met for the merging process. Performing the mergers is indicated by block 336 and determining whether stopping criteria are met is indicated by block 338. The stopping criteria may be a desired number of groups for assignment to a server cluster, as indicated by block 340, or the inability of server cluster identifier 159 to merge any more pairs of groups based on platform constraints or other constraints, as indicated by block 342. The stopping criteria can be a wide variety of other criteria 344 as well.

If the stopping criteria are not met, as indicated by block 346, processing reverts to block 314 where, for each pair of remaining groups, a merger of the groups in the pair is proposed. However, if, at block 346, the stopping criteria have been met, then server cluster identifier 159 generates an output to assign the workloads to server clusters based upon the merged groups. For instance, a merged group of workloads will be assigned to a common cluster. Generating an output to assign the workloads to server clusters based upon the merged groups is indicated by block 348 in the flow diagram of FIG. 5. The output can be provided along with bin packing actions 170 so that cloud control plane 126 can perform the assignment of the workloads to the server clusters, as indicated by block 350. The output can be provided in other ways as well, as indicated by block 352. Once the workloads are assigned to clusters, the workloads can be assigned to nodes within clusters in a similar fashion.

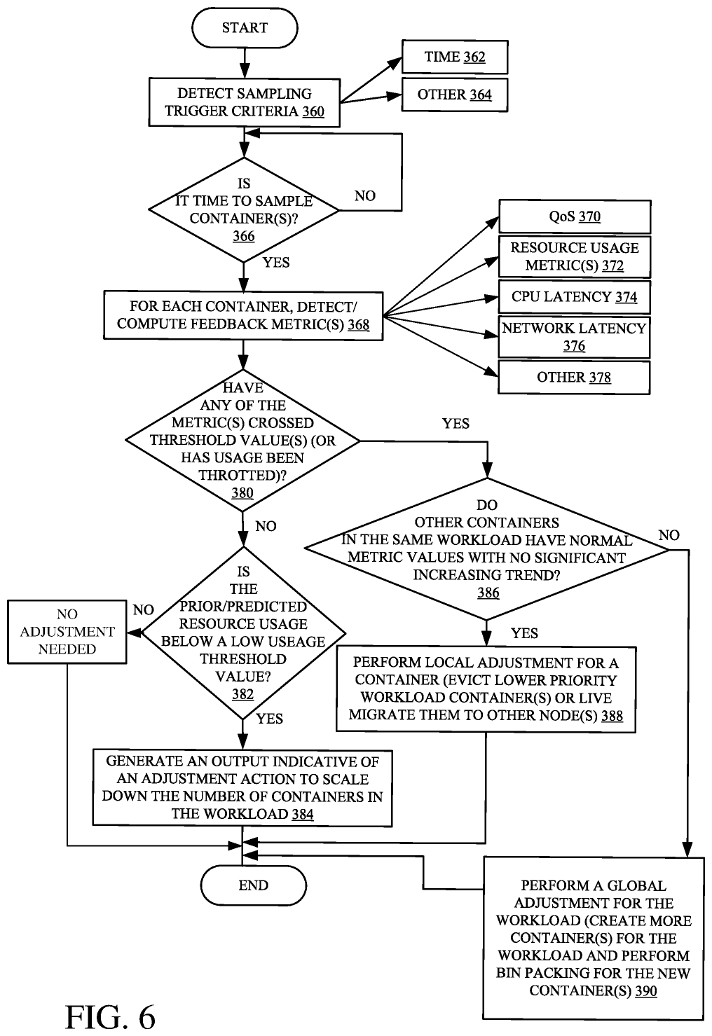

FIG. 6 is a flow diagram illustrating one example of the operation of resource allocation system 124 in continually monitoring the runtime feedback signals from the container monitors 146-148 to make runtime adjustments.

Resource allocation system 104 first detects whether any sampling trigger criteria have been met so that the monitor signals from monitors 146-148 (and other monitors in other workloads) should be sampled. Detecting sampling trigger criteria is indicated by block 360 in the flow diagram of FIG. 6. The sampling criteria may be time based criteria 362 so that resource allocation system 124 samples the monitor signals periodically or otherwise intermittently, based on time. The sampling trigger criteria can be a wide variety of other criteria 364 as well.

If the detected sampling trigger criteria indicates that it is time to sample the containers, as indicated by block 366, then, for each container, the feedback metrics represented in the monitor signals are detected and/or computed, as indicated by block 368. The feedback metrics may be quality of service, as indicated by latency 370, resource usage metrics 372, CPU latency metrics 374, network latency metrics 376, or any of a wide variety of other feedback metrics 378.

Bin packing decision engine 156 first determines whether any of the metrics have crossed a threshold value, or whether the platform has throttled usage of the workload, as indicated by block 380. If not, then bin packing decision engine 156 determines whether the prior or predicted resource usage (as predicted by prediction engine 154) is below a desired threshold value, as indicated by block 382. If so, this means that the resources corresponding to the workload can be scaled down because they are below the low usage threshold value. Therefore, decision engine 156 generates an output, as bin packing action 170, indicative of an adjustment action to scale down the number of containers in the particular workload under analysis. Generating an output to scale down the number of containers is indicated by block 384. This bin packing action 170 is provided to cloud control plane 126 which can scale down the number of containers 142-144 in the particular workload 136 under analysis.

If, at block 380, it is determined that at least one of the metrics has crossed a threshold value, or that the platform has throttled usage, bin packing decision engine 156 determines whether any other containers 142-144 in the same workload have normal metric values with no significant increasing trend predicted by prediction engine 154, as indicated by block 386. If some of the other containers 142-144 do have normal metric values (which do not exceed threshold values) and do not have significant predicted increasing trends, then bin packing decision engine 156 may perform a local adjustment for the container that does have the metric values that have crossed the threshold value, as indicated by block 388. For instance, one of the local adjustments for the container can be to evict lower priority workload containers or live migrate the lower priority containers to other nodes in the server cluster. This will have the effect of releasing some of the resources corresponding to the container.

If, at block 386 it is determined that other containers in the same workload 136 do not have normal metric values (in that they are also exceeding threshold values) or they have normal metric values but have a significant increasing trend predicted by prediction engine 154, then bin packing decision engine 156 performs a global adjustment for the workload which is to create more containers for the workload 136 and perform a global adjustment for the workload, such as by creating more containers for the workload 136 and performing bin packing for the new containers (such as by optimizing the size of the containers and assigning the containers to server clusters and nodes as described above). Performing a global adjustment for the workload is indicated by block 390 in the flow diagram of FIG. 6.

It can thus be seen that the present description describes a system which not only considers platform considerations, but also runtime workload considerations in performing bin packing, including container size adjustment and server cluster and node placement of the containers. This enables the system to perform in a highly efficient way, with fewer resources, and to continuously monitor and adjust the container sizes, server cluster and node placement.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface displays have been discussed. The interfaces can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, they can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

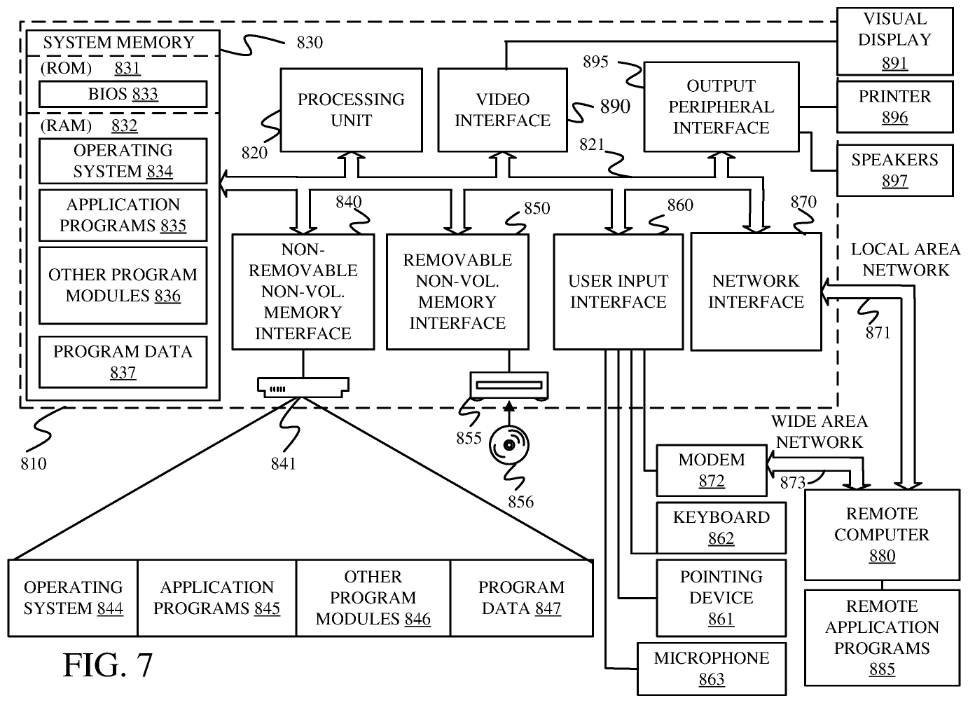

FIG. 7 is one example of a computing environment in which architecture 100, or parts of it, (for example) can be deployed. With reference to FIG. 7, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer system, comprising:
at least one processor; and
a data store that stores computer executable instructions which, when executed by the at least one processor, cause the one or more processor to perform steps, comprising:
performing a first bin packing analysis to identify a first size of a container in which a workload is to run in a cloud computing system and to identify a first server cluster and first server node where the container is to be placed in the cloud computer system;
generating an output to a cloud control plane to deploy the container, with the first container size, to the first server cluster and first server node;
receiving a first runtime feedback signal from the container during runtime of the workload, the first runtime feedback signal being indicative of resource usage by the workload;
receiving a second runtime feedback signal from the container indicative of a quality of service of the workload in the container;
performing a second bin packing analysis to identify a bin packing action to take based on the first runtime feedback signal and the second runtime feedback signals; and
generating a bin packing output signal indicative of the identified bin packing action and providing the bin packing output signal to a cloud control plane for execution of the identified bin packing action.

Example 2 is the computer system of any or all previous examples, the steps further comprising:
generating a predicted resource usage and quality of service of the workload and wherein performing a second bin packing analysis includes performing the second bin packing analysis to identify the bin packing action based on the predicted resource usage and quality of service.

Example 3 is the computer system of any or all previous examples wherein performing a second bin packing analysis comprises:
performing a container optimization analysis to identify a second container size based on the first and second runtime feedback signals.

Example 4 is the computer system of any or all previous examples wherein generating a bin packing output signal comprises:
generating the bin packing output signal indicative of the second container size and an action identifier identifying an action to re-size the container to the second container size.

Example 5 is the computer system of any or all previous examples wherein performing a second bin packing analysis comprises:
performing a server cluster assignment analysis to identify a second server cluster based on the first and second runtime feedback signals.

Example 6 is the computer system of any or all previous examples wherein generating a bin packing output signal comprises:
generating the bin packing output signal indicative of the second server cluster and an action identifier identifying an action to re-assign the container to the second server cluster.

Example 7 is the computer system of any or all previous examples wherein performing a second bin packing analysis comprises:
performing a container optimization analysis to identify a number of containers for the workload based on the first and second runtime feedback signals.

Example 8 is the computer system of any or all previous examples wherein generating a bin packing output signal comprises:
generating the bin packing output signal indicative of the number of containers and an action identifier identifying an action to generate the number of containers.

Example 9 is the computer system of any or all previous examples wherein performing a second bin packing analysis comprises:
calculating a time and space cost of assigning the second container to the second server cluster.

Example 10 is the computer system of any or all previous examples wherein performing a second bin packing analysis comprises:
assign a plurality of containers for a plurality of different workloads by grouping the workloads on a server cluster based on peak usage times for each usage.

Example 11 is the computer system of any or all previous examples, the steps further comprising:
accessing historical usage data for the workload and wherein performing a second bin packing analysis comprises performing the second bin packing analysis based on the historical usage data for the workload.

Example 12 is the computer system of any or all previous examples wherein detecting historical usage data comprises detecting seasonal usage data for the workload, and wherein performing a second bin packing analysis comprises performing the second bin packing analysis based on the seasonal usage data for the workload.

Example 13 is the computer system of any or all previous examples wherein receiving a second runtime feedback signal comprises:
receiving a latency signal indicative of a latency of operation of the workload in the container.

Example 14 is a computer implemented method, comprising:
performing a first bin packing analysis to identify a first size of a container in which a workload is to run in a cloud computing system and to identify a first server cluster and first server node where the container is to be placed in the cloud computer system;
generating an output to a control plane in the cloud computing system to deploy the container, with the first container size, to the first server cluster and first server node;
receiving a runtime feedback signal from the container during runtime of the workload, the runtime feedback signal being indicative of resource usage by the workload;
performing a second bin packing analysis to identify a bin packing action to take based on the runtime feedback signal; and
generating a bin packing output signal indicative of the identified bin packing action and providing the bin packing output signal to a cloud control plane for execution of the identified bin packing action.

Example 15 is the computer implemented method of any or all previous examples and further comprising:
generating a predicted resource usage and latency of the workload and wherein performing a second bin packing analysis includes performing the second bin packing analysis to identify the bin packing action based on the predicted resource usage and latency.

Example 16 is the computer implemented method of any or all previous examples and further comprising:
generating a runtime feedback signal from the container indicative of a latency of operation of the workload in the container.

Example 17 is the computer implemented method of any or all previous examples wherein performing a second bin packing analysis comprises:
performing a container optimization analysis to identify a second container size based on the runtime feedback signal wherein generating a bin packing output signal comprises generating the bin packing output signal indicative of the second container size and an action identifier identifying an action to re-size the container to the second container size.

Example 18 is the computer implemented method of any or all previous examples wherein performing a second bin packing analysis comprises:
performing a server cluster assignment analysis to identify a second server cluster based on the runtime feedback signal and wherein generating a bin packing output signal comprises generating the bin packing output signal indicative of the second server cluster and an action identifier identifying an action to re-assign the container to the second server cluster.

Example 19 is the computer implemented method of any or all previous examples wherein performing a second bin packing analysis comprises:
performing a container optimization analysis to identify a number of containers for the workload based on the runtime feedback signal and wherein generating a bin packing output signal comprises generating the bin packing output signal indicative of the number of containers and an action identifier identifying an action to generate the number of containers.

Example 20 is a computer system, comprising:
a decision engine that performs a first bin packing analysis to identify a first size of a container in which a workload is to run in a cloud computing system and to identifies a first server cluster and first server node where the container is to be placed in the cloud computer system and generates an output to a cloud control plane to deploy the container, with the first container size, to the first server cluster and first server node, the decision engine receiving a runtime feedback signal from the container during runtime of the workload, the runtime feedback signal being indicative of resource usage by the workload and performing a second bin packing analysis to identify a bin packing action to take based on the runtime feedback signal; and
a resource allocation system generating a bin packing output signal indicative of the identified bin packing action and providing the bin packing output signal to a cloud control plane for execution of the identified bin packing action.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system, comprising:
at least one processor; and
a data store that stores computer executable instructions which, when executed by the at least one processor, cause the one or more processor to perform steps, comprising:
performing a first bin packing analysis to identify a first size of a container in which a workload is to run in a cloud computing system and to identify a first server cluster and first server node where the container is to be placed in the cloud computer system;
generating an output to a cloud control plane to deploy the container, with the first container size, to the first server cluster and first server node;
receiving a first runtime feedback signal from the container during runtime of the workload, the first runtime feedback signal being indicative of resource usage by the workload;
receiving a second runtime feedback signal from the container indicative of a quality of service of the workload in the container;
performing a second bin packing analysis to identify a bin packing action to take based on the first runtime feedback signal and the second runtime feedback signals; and
generating a bin packing output signal indicative of the identified bin packing action and providing the bin packing output signal to a cloud control plane for execution of the identified bin packing action.

2. The computer system of claim 1, the steps further comprising:
generating a predicted resource usage and quality of service of the workload and wherein performing a second bin packing analysis includes performing the second bin packing analysis to identify the bin packing action based on the predicted resource usage and quality of service.

3. The computer system of claim 1 wherein performing a second bin packing analysis comprises:
performing a container optimization analysis to identify a second container size based on the first and second runtime feedback signals.

4. The computer system of claim 3 wherein generating a bin packing output signal comprises:
generating the bin packing output signal indicative of the second container size and an action identifier identifying an action to re-size the container to the second container size.

5. The computer system of claim 1 wherein performing a second bin packing analysis comprises:
performing a server cluster assignment analysis to identify a second server cluster based on the first and second runtime feedback signals.

6. The computer system of claim 5 wherein generating a bin packing output signal comprises:
generating the bin packing output signal indicative of the second server cluster and an action identifier identifying an action to re-assign the container to the second server cluster.

7. The computer system of claim 1 wherein performing a second bin packing analysis comprises:
performing a container optimization analysis to identify a number of containers for the workload based on the first and second runtime feedback signals.

8. The computer system of claim 7 wherein generating a bin packing output signal comprises:
generating the bin packing output signal indicative of the number of containers and an action identifier identifying an action to generate the number of containers.

9. The computer system of claim 6 wherein performing a second bin packing analysis comprises:
calculating a time and space cost of assigning the second container to the second server cluster.

10. The computer system of claim 1 wherein performing a second bin packing analysis comprises:
assign a plurality of containers for a plurality of different workloads by grouping the workloads on a server cluster based on peak usage times for each usage.

11. The computer system of claim 1, the steps further comprising:
accessing historical usage data for the workload and wherein performing a second bin packing analysis comprises performing the second bin packing analysis based on the historical usage data for the workload.

12. The computer system of claim 11 wherein detecting historical usage data comprises detecting seasonal usage data for the workload, and wherein performing a second bin packing analysis comprises performing the second bin packing analysis based on the seasonal usage data for the workload.

13. The computer system of claim 1 wherein receiving a second runtime feedback signal comprises:
receiving a latency signal indicative of a latency of operation of the workload in the container.

14. A computer implemented method, comprising:
performing a first bin packing analysis to identify a first size of a container in which a workload is to run in a cloud computing system and to identify a first server cluster and first server node where the container is to be placed in the cloud computer system;
generating an output to a control plane in the cloud computing system to deploy the container, with the first container size, to the first server cluster and first server node;
receiving a runtime feedback signal from the container during runtime of the workload, the runtime feedback signal being indicative of resource usage by the workload;
performing a second bin packing analysis to identify a bin packing action to take based on the runtime feedback signal; and
generating a bin packing output signal indicative of the identified bin packing action and providing the bin packing output signal to a cloud control plane for execution of the identified bin packing action.

15. The computer implemented method of claim 14 and further comprising:
generating a predicted resource usage and latency of the workload and wherein performing a second bin packing analysis includes performing the second bin packing analysis to identify the bin packing action based on the predicted resource usage and latency.

16. The computer implemented method of claim 14 and further comprising:
generating a runtime feedback signal from the container indicative of a latency of operation of the workload in the container.

17. The computer implemented method of claim 14 wherein performing a second bin packing analysis comprises:
performing a container optimization analysis to identify a second container size based on the runtime feedback signal wherein generating a bin packing output signal comprises generating the bin packing output signal indicative of the second container size and an action identifier identifying an action to re-size the container to the second container size.

18. The computer implemented method of claim 14 wherein performing a second bin packing analysis comprises:
performing a server cluster assignment analysis to identify a second server cluster based on the runtime feedback signal and wherein generating a bin packing output signal comprises generating the bin packing output signal indicative of the second server cluster and an action identifier identifying an action to re-assign the container to the second server cluster.

19. The computer implemented method of claim 14 wherein performing a second bin packing analysis comprises:
performing a container optimization analysis to identify a number of containers for the workload based on the runtime feedback signal and wherein generating a bin packing output signal comprises generating the bin packing output signal indicative of the number of containers and an action identifier identifying an action to generate the number of containers.

20. A computer system, comprising:
a decision engine that performs a first bin packing analysis to identify a first size of a container in which a workload is to run in a cloud computing system and to identifies a first server cluster and first server node where the container is to be placed in the cloud computer system and generates an output to a cloud control plane to deploy the container, with the first container size, to the first server cluster and first server node, the decision engine receiving a runtime feedback signal from the container during runtime of the workload, the runtime feedback signal being indicative of resource usage by the workload and performing a second bin packing analysis to identify a bin packing action to take based on the runtime feedback signal; and
a resource allocation system generating a bin packing output signal indicative of the identified bin packing action and providing the bin packing output signal to a cloud control plane for execution of the identified bin packing action.
